(19) United States
(12) Patent Application Publication
(10) Pub. No.: US 2026/0051493 A1
(43) Pub. Date: Feb. 19, 2026

(54) POSITIVE ELECTRODE FOR NONAQUEOUS ELECTROLYTE SECONDARY BATTERIES, AND NONAQUEOUS ELECTROLYTE SECONDARY BATTERY, BATTERY MODULE AND BATTERY SYSTEM EACH USING SAME

(71) Applicant: SEKISUI CHEMICAL CO., LTD., Osaka (JP)

(72) Inventors: Taro MOMOZAKI, Tsukuba-shi (JP); Hikaru YOSHIKAWA, Tsukuba-shi (JP)

(73) Assignee: SEKISUI CHEMICAL CO., LTD., Osaka (JP)

(21) Appl. No.: 19/102,486

(22) PCT Filed: Aug. 31, 2023
(86) PCT No.: PCT/JP2023/031861

§ 371 Date: Feb. 10, 2025

(30) Foreign Application Priority Data
Sep. 2, 2022 (JP) 2022-140042

(51) Int. Cl. H01M 4/58; H01M 4/02; H01M 4/36; H01M 4/62; H01M 4/66; H01M 10/0525; H01M 50/204

(52) U.S. Cl. CPC H01M 4/5825; H01M 4/366; H01M 4/623; H01M 4/625; H01M 4/661; H01M 4/667; H01M 10/0525; H01M 50/204; H01M 2004/028

(57) ABSTRACT

A positive electrode for a non-aqueous electrolyte secondary battery, including a positive electrode current collector and a positive electrode active material layer present on the positive electrode current collector, wherein: the positive electrode current collector has, on at least a part of its surface on a side of the positive electrode active material layer, a current collector coating layer including a conductive material, the positive electrode active material layer includes a positive electrode active material and a conductive carbon, the positive electrode active material includes a compound represented by a formula LiFeₓM₍₁₋ₓ₎PO₄, wherein 0≤x≤1, M is Co, Ni, Mn, Al, Ti or Zr, the positive electrode active material layer has a porosity of 40% or less, and an amount of the conductive carbon is 0.5 to 3.5% by mass with respect to a total mass of the positive electrode active material layer.

### TECHNICAL FIELD

The present invention relates to a positive electrode for non-aqueous electrolyte secondary battery, as well as a non-aqueous electrolyte secondary battery, a battery module, and a battery system, each using the positive electrode.

Priority is claimed on Japanese Patent Application No. 2022-140042, filed Sep. 2, 2022, the contents of which are incorporated herein by reference.

### BACKGROUND ART

A non-aqueous electrolyte secondary battery is generally composed of a positive electrode, a non-aqueous electrolyte, a negative electrode, and a separation membrane (separator) installed between the positive electrode and the negative electrode.

A conventionally known positive electrode for a non-aqueous electrolyte secondary battery is formed by fixing a positive electrode active material layer composed of a composition containing a positive electrode active material containing lithium ions, a conducting agent, and a binder to the surface of a metal foil as a current collector.

Examples of the practically used positive electrode active material containing lithium ions include lithium transition metal composite oxides such as lithium cobalt oxide, lithium nickel oxide, and lithium manganese oxide, and lithium phosphate compounds such as lithium iron phosphate.

Patent Document 1 describes an example in which, in a positive electrode for a lithium-ion secondary battery in which a current collector coating layer containing a conductive agent is provided on the surface of a current collector main body, a positive electrode active material layer is provided thereon, and nickel-cobalt-manganese oxide lithium (NCM) is used as the positive electrode active material, the difference between the surface roughness of the current collector main body and the surface roughness of the current collector coating layer is set to 0.1 μm or more, and the porosity of the positive electrode active material layer is increased to 43 to 64%, thereby improving cycle characteristics.

### CITATION LIST

### Patent Document

Patent Document 1: International Patent Application Publication No. 2018/180742

### SUMMARY OF INVENTION

### Technical Problem

Positive electrode active materials having an olivine crystal structure, such as lithium iron phosphate, are safer than oxide-based active materials such as NCM since the strong covalent bond between phosphorus and oxygen prevents oxygen from being released at high temperatures. However, battery characteristics are likely to be insufficient since the diffusibility of lithium ions and electronic conductivity are low, making the battery characteristics insufficient.

It is known that in non-aqueous electrolyte secondary batteries, the adhesion between the current collector and the positive electrode active material layer affects the battery characteristics. However, no study has been conducted on the adhesion between the current collector and the positive electrode active material layer in non-aqueous electrolyte secondary batteries in which the positive electrode active material is a compound having an olivine crystal structure.

It is also desirable for non-aqueous electrolyte secondary batteries to have battery characteristics that are resistant to degradation even in high-temperature environments.

For addressing this issue, the present invention provides a positive electrode for a non-aqueous electrolyte secondary battery, in which the positive electrode active material is a compound having an olivine crystal structure, and which has high adhesion between a current collector and a positive electrode active material layer and high resistance to high-temperature deterioration.

### Solution to Problem

The embodiments of the present invention are as follows.

[1] A positive electrode for a non-aqueous electrolyte secondary battery, including a positive electrode current collector and a positive electrode active material layer present on the positive electrode current collector, in which:
the positive electrode current collector has, on at least a part of its surface on a side of the positive electrode active material layer, a current collector coating layer including a conductive material,
the positive electrode active material layer includes a positive electrode active material and a conductive carbon,
the positive electrode active material layer includes positive electrode active material particles,
the positive electrode active material particles include coated particles having a core section which is the positive electrode active material and an active material coating section including the conductive carbon,
the positive electrode active material includes a compound represented by a formula LiFeₓM₍₁₋ₓ₎PO₄, wherein 0<x≤1, Mis Co, Ni, Mn, Al, Ti or Zr, the positive electrode active material layer has a porosity of 40% or less, 39% or less, 38% or less, 25 to 40%, 30 to 39%, or 35 to 38%, and an amount of the conductive carbon is 0.5 to 3.5% by mass, 1.0 to 3.0% by mass, 1.2 to 2.8% by mass, or 1.5 to 2.5% by mass with respect to a total mass of the positive electrode active material layer.

[1-1] The positive electrode according to [1], wherein the positive electrode active material layer has the porosity of 30 to 39%, and the amount of the conductive carbon is 1.0 to 2.0% by mass with respect to the total mass of the positive electrode active material layer.

[1-2] The positive electrode according to [1] or [1-1], wherein the amount of the conductive carbon is 1.0 to 2.0% by mass with respect to the total mass of the positive electrode active material layer.

[2] The positive electrode according to any one of [1] to [1-2], wherein the positive electrode active material layer includes a binder, and
wherein the binder includes polyvinylidene fluoride.

[3] A non-aqueous electrolyte secondary battery, including the positive electrode of any one of [1] to [1-2] and [2], a negative electrode, and a non-aqueous electrolyte disposed between the positive electrode and the negative electrode.

[4] A battery module or battery system including a plurality of the non-aqueous electrolyte secondary batteries of [3].

### Advantageous Effects of Invention

The present invention can provide a positive electrode for a non-aqueous electrolyte secondary battery, in which the positive electrode active material is a compound having an olivine crystal structure, and which has high adhesion between a current collector and a positive electrode active material layer and high resistance to high-temperature deterioration.

### BRIEF DESCRIPTION OF DRAWINGS

FIG. 1 is a cross-sectional view schematically showing an example of a positive electrode for a non-aqueous electrolyte secondary battery according to the present invention.

FIG. 2 is a cross-sectional view schematically showing an example of a non-aqueous electrolyte secondary battery according to the present invention.

FIG. 3 is a process diagram for explaining a method for measuring the peel strength of a positive electrode active material layer.

### DESCRIPTION OF EMBODIMENTS

In the present specification and claims. “to” indicating a numerical range means that the numerical values described before and after “to” are included as the lower limit and the upper limit of the range.

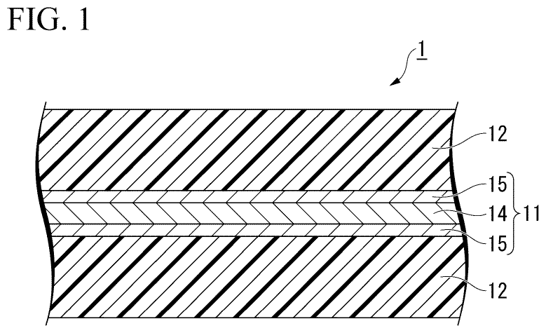

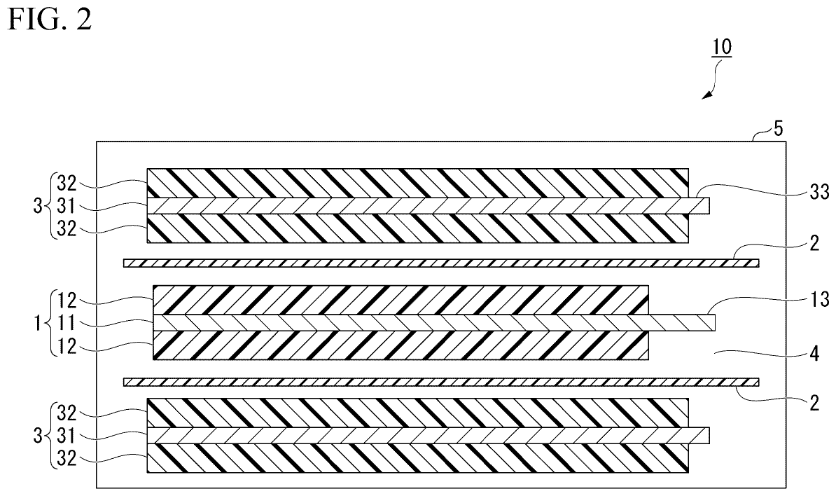

FIG. 1 is a schematic cross-sectional view showing one embodiment of a positive electrode for a non-aqueous electrolyte secondary battery according to the present invention. FIG. 2 is a schematic cross-sectional view showing one embodiment of a non-aqueous electrolyte secondary battery according to the present invention.

FIG. 1 and FIG. 2 are schematic diagrams for facilitating the understanding of the configurations, and the dimensional ratios and the like of each component do not necessarily represent the actual ones.

Hereinbelow, the present invention are described with reference to embodiments of the present invention.

As shown in FIG. 2, the positive electrode for a non-aqueous electrolyte secondary battery of the present embodiment includes a positive electrode 1 (also simply referred to as “positive electrode for a non-aqueous electrolyte secondary battery”), a negative electrode 3, and a non-aqueous electrolyte solution 4 disposed between the positive electrode 1 and the negative electrode 3.

### <Positive Electrode for Non-Aqueous Electrolyte Secondary Battery>

As shown in FIG. 1, the positive electrode 1 of the present embodiment has a current collector (hereinbelow, referred to as “positive electrode current collector”) 11 and a positive electrode active material layer 12.

The positive electrode active material layer 12 of the present embodiment is present on both sides of the positive electrode current collector 11. However, in the present invention, the positive electrode active material layer 12 may be present on only one side of the positive electrode current collector 11.

In the example shown in FIG. 1, the positive electrode current collector 11 has a positive electrode current collector main body 14 and current collector coating layers 15 that cover the positive electrode current collector main body 14 on its surfaces facing the positive electrode active material layers 12. The current collector coating layer 15 contains a conductive material. However, in the present invention, the current collector coating layers 15 may be present on at least a part of the surface of the positive electrode current collector 11 on the side of the positive electrode active material layer 12.

### [Positive Electrode Active Material Layer]

The positive electrode active material layer 12 includes a positive electrode active material and a conductive carbon.

The positive electrode active material layer 12 preferably contains positive electrode active material particles, which are particles containing a positive electrode active material. The positive electrode active material particles preferably include coated particles having a core section which is a positive electrode active material and an active material coating section which contains conductive carbon.

The positive electrode active material layer 12 preferably further includes a binder.

The positive electrode active material layer 12 may further include a conducting agent. In the context of the present specification, the term “conducting agent” refers to a conductive material of a particulate shape, a fibrous shape, etc., which is mixed with the positive electrode active material particles for the preparation of the positive electrode active material layer, and is caused to be present in the positive electrode active material layer in a form connecting the positive electrode active material particles. The conducting agent preferably contains conductive carbon. The conducting agent is present independently of the positive electrode active material particles.

The positive electrode active material layer 12 may further include a dispersant.

The amount of the positive electrode active material particles is preferably 80.0 to 99.9% by mass, and more preferably 90 to 99.5% by mass, based on the total mass of the positive electrode active material layer 12.

The thickness of the positive electrode active material layer (total thickness of the positive electrode active material layers in the case where the positive electrode active material layers are formed on both sides of the positive electrode current collector) is preferably 20 to 500 μm, more preferably 25 to 300 μm, and particularly preferably 30 to 200 μm. When the thickness of the positive electrode active material layer is not less than the lower limit value of the above range, the energy density of a battery with the positive electrode incorporated therein tends to improve. When the thickness is not more than the upper limit value of the above range, the effect of reducing the internal resistance of the electrode is excellent.

### [Positive Electrode Active Material Particles]

The positive electrode active material particles include a positive electrode active material. At least a part of the positive electrode active material particles are preferably coated particles having a core section formed of a positive electrode active material and an active material coating section which contains a conductive carbon.

In the coated particles, a coated section containing a conductive material (hereinafter, also referred to as “active material coating section”) is present on the surfaces of the positive electrode active material particles. The active material coating section of the active material particles enables the positive electrode active material particles to further enhance the battery capacity and cycling performance.

For example, the active material coating section is formed in advance on the surface of the positive electrode active material particles, and is present on the surface of the positive electrode active material particles in the positive electrode active material layer. That is, the active material coating section in the context of the present specification is not one newly formed in the steps following the preparation step of a positive electrode composition. In addition, the active material coating section is not one that easily comes off in the steps following the preparation step of a positive electrode composition.

For example, the active material coating section stays on the surface of the positive electrode active material particles even when the coated particles are mixed with a solvent by a mixer or the like during the preparation of a positive electrode composition. Further, the active material coating section stays on the surface of the positive electrode active material particles even when the positive electrode active material layer is detached from the positive electrode and then put into a solvent to dissolve the binder contained in the positive electrode active material layer in the solvent. Furthermore, the active material coating section stays on the surface of the positive electrode active material particles even when an operation to disintegrate agglomerated particles is implemented for measuring the particle size distribution of the particles in the positive electrode active material layer by the laser diffraction scattering method.

The active material coating section preferably covers 50% or more, preferably 70% or more, and more preferably 90% or more of the total area of the entire outer surfaces of the positive electrode active material particles.

That is, the coated particles have a core section that is a positive electrode active material and an active material coating section that covers the surface of the core section, and the area ratio (coverage) of the active material coating section with respect to the surface area of the core section is preferably 50% or more, more preferably 70% or more, and even more preferably 90% or more.

Examples of the method for producing the coated particles include a sintering method and a vapor deposition method.

Examples of the sintering method include a method that sinters an active material composition (for example, a slurry) containing the positive electrode active material particles and an organic substance at 500 to 1000° C., for 1 to 100 hours under atmospheric pressure. Examples of the organic substance added to the active material composition include salicylic acid, catechol, hydroquinone, resorcinol, pyrogallol, fluoroglucinol, hexahydroxybenzene, benzoic acid, phthalic acid, terephthalic acid, phenylalanine, water dispersible phenolic resins, saccharides (e.g., sucrose, glucose and lactose), carboxylic acids (e.g., malic acid and citric acid), unsaturated monohydric alcohols (e.g., allyl alcohol and propargyl alcohol), ascorbic acid, and polyvinyl alcohol. This sintering method sinters an active material composition to allow carbon in the organic substance to be fused to the surface of the positive electrode active material to thereby form the active material coating section.

Another example of the sintering method is the so-called impact sintering coating method.

The impact sintering coating method is carried out, for example, as follows. In an impact sintering coating device, a burner is ignited using a mixture of hydrocarbon fuel and oxygen, and a flame is generated by burning the mixture in a combustion chamber. In this process, the amount of oxygen is reduced to an amount equivalent to complete combustion of the fuel or less to lower the flame temperature. A powder supply nozzle is installed behind the flame, and a solid-liquid-gas three-phase mixture consisting of a solution obtained by dissolving an organic substance for coating in a solvent, and a combustion gas is sprayed from the powder supply nozzle. By increasing the amount of combustion gas maintained at room temperature, the temperature of the sprayed fine powder is lowered, and the sprayed fine powder is accelerated at a temperature below the transformation temperature, sublimation temperature or evaporation temperature of the powder material, and is instantly sintered by impact to coat the positive electrode active material particles.

Examples of the vapor deposition method include a vapor phase deposition method such as a physical vapor deposition method (PVD) and a chemical vapor deposition method (CVD), and a liquid phase deposition method such as plating.

The coverage can be measured by a method as follows. First, the particles in the positive electrode active material layer are analyzed by the energy dispersive X-ray spectroscopy (TEM-EDX) using a transmission electron microscope. Specifically, an elemental analysis is performed by EDX with respect to the outer peripheral portion of the positive electrode active material particles in a TEM image. The elemental analysis is performed on carbon to identify the carbon coating the positive electrode active material particles. A section with a carbon coating having a thickness of 1 nm or more is defined as a coating section, and the ratio of the coating section with respect to the entire circumference of the observed positive electrode active material particle can be determined as the coverage. The measurement can be performed with respect to, for example, 10 positive electrode active material particles, and an average value thereof can be used as a value of the coverage.

Further, the active material coating section is a layer directly formed on the surface of particles (core section) composed of only the positive electrode active material, which has a thickness of 1 nm to 100 nm, and preferably 5 nm to 50 nm. This thickness can be determined by the above-mentioned TEM-EDX used for the measurement of the coverage.

In the present embodiment, the coverage of the coated particles (the area of the active material coating section with respect to the surface area of the core section) is particularly preferably 100%.

This coverage is an average value for all the positive electrode active material particles present in the positive electrode active material layer. As long as this average value is not less than the above lower limit value, the positive electrode active material layer may contain positive electrode active material particles without the active material coating section. When the positive electrode active material particles (single particles) without the active material coating section are present in the positive electrode active material layer, the amount thereof is preferably 30% by mass or less, more preferably 20% by mass or less, and particularly preferably 10% by mass or less, with respect to the total mass of the positive electrode active material particles present in the positive electrode active material layer. In one embodiment, it is preferred that single particles are not present in the positive electrode active material layer.

The conductive material constituting the active material coating section includes carbon (conductive carbon). The conductive material may be composed only of carbon, or may be a conductive organic compound containing carbon and other elements other than carbon. Examples of the other elements include nitrogen, hydrogen, oxygen and the like. In the conductive organic compound, the amount of the other elements is preferably 10 atomic % or less, and more preferably 5 atomic % or less. It is more preferable that the conductive material constituting the active material coating section is composed only of carbon.

The amount of the conductive material is preferably 0.1 to 4.0% by mass, more preferably 0.5 to 3.0% by mass, and even more preferably 0.7 to 2.5% by mass, with respect to the total mass of the positive electrode active material particles having the active material coating section. When the amount is equal to or less than the upper limit of the above range, the conductive material is less likely to come off the surface of the positive electrode active material particles and less likely remain as isolated conducting agent particles.

Conductive particles that do not contribute to the creation of conductive path may become a site where self-discharge of the battery starts or a cause of undesirable side reactions.

When the active material coating section is formed of carbon, it is preferably amorphous carbon.

The method for producing positive electrode active material particles having amorphous carbon as the active material coating section is not particularly limited, and any known method can be used. Examples thereof include a method in which a graphitizable resin or a non-graphitizable resin, naphthalene, coal tar, binder pitch, etc. is added as a carbon precursor to the positive electrode active material particles and the resulting is heat-treated at 600 to 1300° C. Also, examples thereof include a method in which fluidized positive electrode active material particles are subjected to chemical vapor deposition by heat treatment at 600 to 1300° C. using hydrocarbon compounds such as methanol, ethanol, benzene, and toluene as a chemical vapor deposition carbon source, to thereby form a carbon coating on the surfaces of the positive electrode active material particles. The majority of the carbon that constitutes the active material coating section formed by these methods is amorphous.

When the active material coating section is formed of carbon nanotubes, graphene, or the like, which are highly conductive and highly crystalline, instead of amorphous carbon, the resistance of the active material coating section becomes too low, and side reactions with the electrolyte solution increase during charge-discharge cycles, resulting in a decrease in the battery life. That is, when the active material coating section is formed of amorphous carbon, the resistance of the active material coating section does not become too low, and side reactions with the electrolyte solution during charge-discharge cycles is suppressed, resulting in an increase in the battery life.

For example, by checking the sp² bond ratio from the difference in the shape of the EELS spectrum (C-K edge), it is possible to determine whether the carbon in the active material coating section is crystalline or amorphous. Similarly, by checking the peak positions in the wavenumber range of 1200 cm 1 to 1800 cm⁻¹ in the Raman spectrum, it is possible to determine whether the carbon in the active material coating section is crystalline or amorphous.

It is preferable that the proportion of amorphous carbon in the active material coating section is higher than the proportion of crystalline carbon.

The positive electrode active material particles contain a compound (I) represented by a formula LiFeₓM₍₁₋ₓ₎PO₄ (hereinafter, also referred to as “formula (I)”). The compound (I) is a compound having an olivine crystal structure. In the formula (I), 0≤x≤1. Mis Co, Ni. Mn, Al, Ti or Zr. A minute amount of Fe and M (Co, Ni, Mn, Al, Ti or Zr) may be replaced with another element so long as the replacement does not affect the physical properties of the compound. The presence of a trace amount of metal impurities in the compound (I) represented by the formula (I) does not impair the effect of the present invention.

The compound (I) represented by the formula (I) is preferably lithium iron phosphate represented by LiFePO₄ (hereinafter, also simply referred to as “lithium iron phosphate”).

The positive electrode active material particles are more preferably lithium iron phosphate particles having, on at least a part of their surfaces, an active material coating section including a conductive material (hereinafter, also referred to as “coated lithium iron phosphate particles”). It is more preferable that the entire surface of lithium iron phosphate particles is coated with a conductive material for achieving more excellent battery capacity and cycling performance.

The coated lithium iron phosphate particles can be produced by a known method.

The active material coating section of the coated lithium iron phosphate particles is preferably composed of low-crystalline carbon in which the proportion of amorphous carbon is higher than the proportion of crystalline carbon.

There are no particular limitations on the producing method for obtaining lithium iron phosphate particles coated with low-crystalline carbon, however examples thereof include a method in which the carbon precursor is added to lithium iron phosphate particles and then heat-treated, or a method in which the lithium iron phosphate particles are fluidized while being subjected to chemical vapor deposition treatment using the chemical vapor deposition carbon source to form a carbon coating on the surface.

The particle size of the iron phosphate particles can be adjusted by the grinding time in the grinding process, etc. The amount of carbon coating the lithium iron phosphate powder can be adjusted by the temperature and time of the carbon coating process. It is desirable to remove uncoated carbon particles by subsequent processes such as classification and washing.

The positive electrode active material particles may include at least one type of other positive electrode active material particles including other positive electrode active materials than the compound (I) represented by the formula (I).

Preferable examples of the other positive electrode active materials include a lithium transition metal composite oxide. Specific examples thereof include lithium cobalt oxide, lithium nickel oxide, lithium nickel cobalt aluminum oxide (LiNiₓCo_{y}Al_{z}O₂ with the proviso that x+y+z=1), lithium nickel cobalt manganese oxide (LiNiₓCo_{y}Mn_{z}O₂ with the proviso that x+y+z=1), lithium manganese oxide, lithium manganese cobalt oxide, lithium manganese chromium oxide, lithium vanadium nickel oxide, nickel-substituted lithium manganese oxide (e.g., LiMn_{1.5}Ni_{0.5}O₄), and lithium vanadium cobalt oxide, as well as nonstoichiometric compounds formed by partially substituting the compounds listed above with metal elements. Examples of the metal element include one or more selected from the group consisting of Mn, Mg. Ni, Co, Cu, Zn and Ge.

The other positive electrode active material particles may have, on at least a part of surfaces thereof, the active material coating section described above.

The amount of the compound represented by the formula (I) is preferably 50% by mass or more, more preferably 80% by mass or more, and even more preferably 90% by mass or more, based on the total mass of the positive electrode active material particles. This amount may be 100% by mass. The amount of the compound represented by the formula (I) is preferably 50 to 100% by mass, more preferably 80 to 100% by mass, and even more preferably 90 to 100% by mass, based on the total mass of the positive electrode active material particles.

When the coated lithium iron phosphate particles are used, the amount of the coated lithium iron phosphate particles is preferably 50% by mass or more, more preferably 80% by mass or more, and even more preferably 90% by mass or more, based on the total mass of the positive electrode active material particles. This amount may be 100% by mass. When the coated lithium iron phosphate particles are used, the amount of the coated lithium iron phosphate particles is preferably 50 to 100% by mass, more preferably 80 to 100% by mass, and even more preferably 90 to 100% by mass, based on the total mass of the positive electrode active material particles.

The thickness of the active material coating section of the positive electrode active material particles is preferably 1 to 100 nm.

The thickness of the active material coating section of the positive electrode active material particles can be measured by a method of measuring the thickness of the active material coating section in a transmission electron microscope (TEM) image of the positive electrode active material particles. The thickness of the active material coating sections on the surfaces of the positive electrode active material particles need not be uniform. It is preferable that the positive electrode active material particles have, on at least a part of surfaces thereof, the active material coating section having a thickness of 1 nm or more, and the maximum thickness of the active material coating section is 100 nm or less.

The average particle size of the positive electrode active material particles is preferably 0.1 to 20.0 μm, and more preferably 0.5 to 15.0 μm. When two or more types of positive electrode active material particles are used, the average particle size of each of such positive electrode active material particles may be within the above range.

When the average particle size is not less than the lower limit value of the above range, the dispersibility in the positive electrode composition is improved, and agglomerates are less likely to occur. On the other hand, when the average particle size is not more than the upper limit value of the above range, the specific surface area becomes appropriately large, making it easier to secure an area for reaction during charging and discharging.

The average particle size of the positive electrode active material particles in the present specification is a volume-based median particle size measured using a laser diffraction/scattering particle size distribution analyzer.

### [Binder]

The binder that can be contained in the positive electrode active material layer 12 is an organic substance, and examples thereof include polyacrylic acid, lithium polyacrylate, polyvinylidene fluoride, polyvinylidene fluoride-hexafluoropropylene copolymers, styrene butadiene rubbers, polyvinyl alcohol, polyvinyl acetal, polyethylene oxide, polyethylene glycol, carboxymethyl cellulose, polyacrylic nitrile, and polyimide. With respect to the binder, a single type thereof may be used alone or two or more types thereof may be used in combination.

The binder preferably contains polyvinylidene fluoride.

When the positive electrode active material layer contains a binder, the amount of the binder with respect to the total mass of the positive electrode active material layer is preferably 0.1 to 4.0% by mass, more preferably 0.3 to 3.0% by mass, and even more preferably 0.5 to 2.0% by mass When the amount of binder is not less than the lower limit value of the above range, the positive electrode active material is sufficiently bound, and the mechanical strength of the positive electrode is obtained. When the amount of binder is not more than the upper limit value of the above range, the proportion of substances that do not contribute to ion conduction is reduced, and the internal resistance of the electrode can be reduced.

### [Conducting Agent]

Known conducting agent can be used as the conducting agent contained in the positive electrode active material layer 12.

Examples of the conducting agent containing conductive carbon include graphite, graphene, hard carbon, Ketjen black, acetylene black, carbon nanotube, and the like. With respect to the conducting agent, a single type thereof may be used alone or two or more types thereof may be used in combination.

The amount of the conducting agent in the positive electrode active material layer is, for example, preferably less than 3 parts by mass, more preferably less than 2 parts by mass, and even more preferably 1 part by mass or less, with respect to 100 parts by mass of the total mass of the positive electrode active material. It is particularly preferable that the positive electrode active material layer does not contain a conducting agent, and it is desirable that there are no isolated conducting agent particles (for example, isolated carbon particles).

When the amount of conducting agent is not more than the upper limit, the positive electrode active material layer has with less reactive sites.

When the conducting agent is incorporated into the positive electrode active material layer, the lower limit value of the amount of the conducting agent is appropriately determined according to the type of the conducting agent, and is, for example, more than 0.1% by mass, based on the total mass of the positive electrode active material layer.

In the context of the present specification, the expression “the positive electrode active material layer does not contain a conducting agent” or similar expression means that the positive electrode active material layer does not substantially contain a conducting agent, and should not be construed as excluding a case where a conducting agent is contained in such an amount that the effects of the present invention are not affected. For example, if the amount of the conducting agent is 0.1% by mass or less, based on the total mass of the positive electrode active material layer, then, it is judged that substantially no conducting agent is contained.

Conducting agent particles that do not contribute to the creation of conductive path may become a site where self-discharge of the battery starts or a cause of undesirable side reactions.

### [Dispersant]

The dispersant contained in the positive electrode active material layer 12 is an organic substance, and examples thereof include polyvinylpyrrolidone, polyvinyl alcohol, polyvinyl butyral, and polyvinylformal. With respect to these dispersants, a single type thereof may be used individually or two or more types thereof may be used in combination. The dispersant contributes to improving the dispersibility of the particles in the positive electrode active material layer. On the other hand, when the amount of the dispersant is too high, the internal resistance of the electrode is likely to increase.

The amount of the dispersant is preferably 0.5% by mass or less, and more preferably 0.2% by mass or less, based on the total mass of the positive electrode active material layer.

When the positive electrode active material layer contains a dispersant, the lower limit of the amount of the dispersant is preferably 0.01% by mass or more, and more preferably 0.05% by mass or more, based on the total mass of the positive electrode active material layer. When the positive electrode active material layer contains a dispersant, the amount of the dispersant is preferably 0.01 to 0.5% by mass, and more preferably 0.05 to 0.2% by mass.

### [Positive Electrode Current Collector Main Body]

The positive electrode current collector main body 14 is formed of a metal material. Examples of the metal material include conductive metals such as copper, aluminum, titanium, nickel, and stainless steel.

The positive electrode current collector main body 14 is a foil made of a metal material, that is, a metal foil, and may include an oxide film formed on the surface.

The thickness of the positive electrode current collector main body 14 is preferably, for example, 8 to 40 μm, and more preferably 10 to 25 μm.

The thickness of the positive electrode current collector main body 14 and the thickness of the positive electrode current collector 11 can be measured using a micrometer. One example of the measuring instrument usable for this purpose is an instrument with the product name “MDH-25M”, manufactured by Mitutoyo Co., Ltd.

### [Current Collector Coating Layer]

The positive electrode current collector main body 14 has, on at least a part of its surface, a current collector coating layer 15. The current collector coating layer 15 contains a conductive material.

In this context, the expression “at least a part of its surface” means 10% to 100%, preferably 30% to 100%, and more preferably 50% to 100% of the area of the surface of the positive electrode current collector main body.

The conductive material in the current collector coating layer 15 preferably contains carbon (conductive carbon). The conductive material is more preferably one composed only of carbon.

The current collector coating layer 15 is preferred to be, for example, a coating layer containing carbon particles such as carbon black and a binder. Examples of the binder for the current collector coating layer 15 include those listed above as examples of the binder for the positive electrode active material layer 12.

With regard to the production of the positive electrode current collector 11 in which the surface of the positive electrode current collector main body 14 is coated with the current collector coating layer 15, for example, the production can be implemented by a method in which a composition for preparing the current collector coating layer containing the conductive material, the binder, and a solvent is applied to the surface of the positive electrode current collector main body 14 with a known coating method such as a gravure method, followed by drying to remove the solvent.

The thickness of the current collector coating layer 15 is preferably 0.01 to 7.0 μm, more preferably 0.1 to 5.0 μm, and even more preferably 0.2 to 2.0 μm. When the thickness of the current collector coating layer is within the above range, a uniform coating layer free of cracks and pinholes can be formed, and an increase in battery weight due to the film thickness and the internal resistance of the electrode can be reduced.

The thickness of the current collector coating layer can be measured by a method of measuring the thickness of the coating layer in a transmission electron microscope (TEM) image or a scanning electron microscope (SEM) image of a cross section of the current collector coating layer. The thickness of the current collector coating layer need not be uniform. It is preferable that the current collector coating layer having a thickness equal to or more than the lower limit of the above range is present on at least a part of the surface of the positive electrode current collector main body 14, and the maximum thickness of the current collector coating layer is equal to or less than the upper limit of the above range.

When the current collector coating layers 15 are present on both surfaces of the positive electrode current collector main body 14, an average of the thickness values on the both surfaces may be within the above range.

### [Amount of Conductive Carbon]

In the present embodiment, the positive electrode active material layer 12 contains conductive carbon.

The amount of the conductive carbon is 0.5 to 3.5% by mass, preferably 1.0 to 3.0% by mass, more preferably 1.0 to 2.8% by mass, even more preferably 1.0% by mass or more and less than 2.5% by mass, and particularly preferably 1.0 to 2.0% by mass, with respect to the total mass of the positive electrode active material layer.

When the amount of conductive carbon in the positive electrode active material layer is not more than the lower limit value of the above range, the positive electrode active material layer has excellent conductive path formation and low resistance characteristics. When the amount of conductive carbon in the positive electrode active material layer is not less than the upper limit, the positive electrode active material layer can be formed with less isolated conductive carbon and fewer reactive active sites.

The amount of conductive carbon with respect to the total mass of the positive electrode active material layer can be calculated based on the carbon content and blending amount of the active material, and the carbon content and blending amount of the conducting agent. Or, the amount of conductive carbon with respect to the total mass of the positive electrode active material layer can be measured by <<Method for measuring amount of conductive carbon>> described below with respect to a dried product (the dried product is a powder), as a measurement target, obtained by vacuum-drying, at 120° C., the positive electrode active material layer detached from the positive electrode.

For example, the measurement target may be one obtained by detaching the outermost surface of the positive electrode active material layer with a depth of several μm using a spatula or the like, and vacuum drying the resulting powder in an environment of 120° C.

The conductive carbon to be measured by the <<Method for measuring amount of conductive carbon>> described below includes carbon in the active material coating section and carbon in the conducting agent, but does not include carbon in the binder and carbon in the dispersant.

### <<Method for Measuring Amount of Conductive Carbon>>

### [Measurement Method A]

A sample having a weight w1 is taken from a homogeneously mixed product of the measurement target, and the sample is subjected to thermogravimetry differential thermal analysis (TG-DTA) implemented by following steps A1 and A2 defined below, to obtain a TG curve. From the obtained TG curve, the following first weight loss amount M1 (unit: % by mass) and second weight loss amount M2 (unit: % by mass) are obtained. By subtracting M1 from M2, the amount of the conductive carbon (unit: % by mass) is obtained.

Step A1: The temperature of the sample is raised from 30° C., to 600° C., at a heating rate of 10° C./min and the temperature is held at 600° C., for 10 minutes in an argon gas stream of 300 mL/min to measure a resulting mass w2 of the sample, from which a first weight loss amount M1 is determined by formula (a1):

$$M 1 = ( w 1 - w 2 ) / w 1 \times 100 \qquad ( a 1 )$$

Step A2: Immediately after the step A1, the temperature is lowered from 600° C., to 200° C., at a cooling rate of 10° C./min and held at 200° C., for 10 minutes, followed by completely substituting the argon gas stream with an oxygen gas stream.

The temperature is raised from 200° C., to 1000° C., at a heating rate of 10° C./min and held at 1000° C., for 10 minutes in an oxygen gas stream of 100 ml/min to measure a resulting mass w3 of the sample, from which a second weight loss amount M2 (unit: % by mass) is determined by formula (a2):

$$M 2 = ( w 1 - w 3 ) / w 1 \times 100 \qquad ( a 2 )$$

### [Measurement Method B]

0.0001 mg of a precisely weighed sample is taken from a homogeneously mixed product of the measurement target, and the sample is burnt under burning conditions defined below to measure an amount of generated carbon dioxide by a CHN elemental analyzer, from which a total carbon amount M3 (unit: % by mass) of the sample is determined. Also, a first weight loss amount M1 is determined following the procedure of the step A1 of the measurement method A. By subtracting M1 from M3, the amount of conductive carbon (unit: % by mass) is obtained.

### [Burning Conditions]

Temperature of combustion furnace: 1150° C.
Temperature of reduction furnace: 850° C.
Helium flow rate: 200 mL/min.
Oxygen flow rate: 25 to 30 ml/min.

### [Measurement Method C]

The total carbon amount M3 (unit: % by mass) of the sample is measured in the same manner as in the above measurement method B. Further, the carbon amount M4 (unit: % by mass) of carbon derived from the binder is determined by the following method. M4 is subtracted from M3 to determine the amount of the conductive carbon (unit: % by mass).

When the binder is polyvinylidene fluoride (PVDF: monomer (CH₂CF₂), molecular weight 64), the amount of conductive carbon can be calculated by the following formula from the fluoride ion (F) amount (unit: % by mass) measured by combustion ion chromatography based on the tube combustion method, the atomic weight (19) of fluorine in the monomers constituting PVDF, and the atomic weight (12) of carbon constituting PVDF.

$$PVDF amount ( unit : \% by mass ) = fluoride ion amount ( unit : \% by mass ) \times 64 / 38$$

$$PVDF - derived carbon amount M 4 ( unit : \% by mass ) = fluoride ion amount ( unit : \% by mass ) \times 12 / 19$$

The presence of polyvinylidene fluoride as a binder can be verified by a method in which a sample or a liquid obtained by extracting a sample with an N,N-dimethylformamide solvent is subjected to Fourier transform infrared spectroscopy to confirm the absorption attributable to the C—F bond. Such verification can be likewise implemented by fluorine nucleus nuclear magnetic resonance spectroscopy (19F-NMR).

When the binder is identified as being other than PVDF, the carbon amount M4 attributable to the binder can be calculated by determining the amount (unit: % by mass) of the binder from the measured molecular weight, and the carbon amount (unit: % by mass).

When the dispersant is contained, the amount of the conductive carbon (unit: % by mass) can be obtained by subtracting M4 from M3, and further subtracting therefrom the amount of carbon belonging to the dispersant.

These methods are described in the following publications:
Toray Research Center, The TRC News No. 117 (September 2013), pp. 34-37, [Searched on Feb. 10, 2021], Internet <https://www.toray-research.co.jp/technical-info/trcnews/pdf/TRC117 (34-37).pdf>
TOSOH Analysis and Research Center Co., Ltd., Technical Report No. T1019 2017.09.20, [Searched on Feb. 10, 2021], Internet <http://www.tosoh-arc.co.jp/techrepo/files/tarc00522/T1719N.pdf>

### <<Analytical Method for Conductive Carbon>>

The conductive carbon in the active material coating section of the positive electrode active material and the conductive carbon as the conducting agent can be distinguished by the following analytical method.

For example, particles in the positive electrode active material layer are analyzed by a combination of transmission electron microscopy-electron energy loss spectroscopy (TEM-EELS), and particles having a carbon-derived peak around 290 eV only near the particle surface can be judged to be the positive electrode active material. On the other hand, particles having a carbon-derived peak inside the particles can be judged to be the conducting agent. In this context, “near the particle surface” means a region to the depth of approximately 100 nm from the particle surface, while “inside” means an inner region positioned deeper than the “near the particle surface”.

As another method, the particles in the positive electrode active material layer are analyzed by Raman spectroscopy mapping, and particles showing carbon-derived G-band and D-band as well as a peak of the positive electrode active material-derived oxide crystals can be judged to be the positive electrode active material. On the other hand, particles showing only G-band and D-band can be judged to be the conducting agent.

As still another method, a cross section of the positive electrode active material layer is observed with scanning spread resistance microscope (Scanning Spread Resistance Microscope). When the particle surface has a region with lower resistance than the inside of the particle, the region with lower resistance can be judged to be the conductive carbon present in the active material coating section. Other particles that are present isolatedly and have low resistance can be judged to be the conducting agent. In this context, a trace amount of carbon considered to be an impurity and a trace amount of carbon unintentionally detached from the surface of the positive electrode active material during production are not judged to be the conducting agent.

Using any of these methods, it is possible to verify whether or not the conducting agent formed of carbon material is contained in the positive electrode active material layer.

### <Method for Producing Positive Electrode>

The method for producing the positive electrode 1 of the present embodiment includes a composition preparation step of preparing a positive electrode composition containing a positive electrode active material, and a coating step of coating the positive electrode composition on the positive electrode current collector 11.

For example, the positive electrode 1 can be produced by applying the positive electrode composition containing a positive electrode active material and a solvent onto the positive electrode current collector 11, followed by drying to remove the solvent to form the positive electrode active material layer 12. The positive electrode composition may contain a conducting agent. The positive electrode composition may contain a binder. The positive electrode composition may contain a dispersant.

The thickness of the positive electrode active material layer 12 can be adjusted by a method in which a layered body composed of the positive electrode current collector 11 and the positive electrode active material layer 12 formed thereon is placed between two flat plate jigs and, then, uniformly pressurized in the thickness direction of this layered body. For this purpose, for example, a method of pressurizing using a roll press can be used.

The pressure (pressing pressure) applied when pressing the layered body is, for example, preferably a linear pressure of 0.6 to 2.5 kN/m, and more preferably 1.0 to 2.4 kN/m.

The solvent for the positive electrode composition is preferably a non-aqueous solvent. Examples of the solvent include alcohols such as methanol, ethanol. 1-propanol and 2-propanol; chain or cyclic amides such as N-methylpyrrolidone and N,N-dimethylformamide; and ketones such as acetone. With respect to these solvents, a single type thereof may be used individually or two or more types thereof may be used in combination.

### <Non-Aqueous Electrolyte Secondary Battery>

The non-aqueous electrolyte secondary battery 10 of the present embodiment shown in FIG. 2 includes a positive electrode 1 of the present embodiment, a negative electrode 3, and a non-aqueous electrolyte solution 4. The non-aqueous electrolyte secondary battery 10 may further include a separator 2. Reference numeral 5 in FIG. 2 denotes an outer casing.

In the present embodiment, the positive electrode 1 has a plate-shaped (sheet like) positive electrode current collector 11 and positive electrode active material layers 12 provided on both surfaces thereof. The positive electrode active material layer 12 is present on a part of each surface of the positive electrode current collector 11. The edge of the surface of the positive electrode current collector 11 is a positive electrode current collector exposed section 13, which is free of the positive electrode active material layer 12. The conductive layer 15 may be present on the surface of the positive electrode current collector exposed section 13, or the conductive layer 15 may not be present. That is, the positive electrode current collector main body 14 may be exposed. A terminal tab (not shown) is electrically connected to an arbitrary portion of the positive electrode current collector exposed section 13.

In the present embodiment, the negative electrode 3 has a plate-shaped (sheet like) negative electrode current collector 31 and negative electrode active material layers 32 provided on both surfaces thereof. The negative electrode active material layer 32 is present on a part of each surface of the negative electrode current collector 31. The edge of the surface of the negative electrode current collector 31 is a negative electrode current collector exposed section 33, which is free of the negative electrode active material layer 32. A terminal tab (not shown) is electrically connected to an arbitrary portion of the negative electrode current collector exposed section 33.

The shapes of the positive electrode 1, the negative electrode 3 and the separator 2 are not particularly limited. For example, each of these may have a rectangular shape in a plan view.

FIG. 2 shows a representative example of a structure of the battery in which the negative electrode, the separator, the positive electrode, the separator, and the negative electrode are stacked in this order, but the number of electrodes can be altered as appropriate. The number of the positive electrode 1 may be one or more, and any number of positive electrodes 1 can be used depending on the battery capacity to be obtained. The number of each of the negative electrode 3 and the separator 2 is larger by one sheet than the number of the positive electrode 1, and these are stacked so that the negative electrode 3 is located at the outermost layer.

### [Negative Electrode]

The negative electrode active material layer 32 includes a negative electrode active material. The negative electrode active material layer 32 may further includes a binder. The negative electrode active material layer 32 may further include a conducting agent. The shape of the negative electrode active material is preferably particulate.

For example, the negative electrode 3 can be produced by a method in which a negative electrode composition containing a negative electrode active material, a binder and a solvent is prepared, and coated on the negative electrode current collector 31, followed by drying to remove the solvent to thereby form a negative electrode active material layer 32. The negative electrode composition may contain a conducting agent.

Examples of the negative electrode active material and the conducting agent include carbon materials, lithium titanate, silicon, silicon monoxide and the like. Examples of the carbon materials include graphite, graphene, hard carbon, Ketjen black, acetylene black, and carbon nanotube. With respect to each of the negative electrode active material and the conducting agent, a single type thereof may be used alone or two or more types thereof may be used in combination.

Examples of the material of the negative electrode current collector 31 include those listed above as examples of the material of the positive electrode current collector 11.

Examples of the binder in the negative electrode composition include polyacrylic acid, lithium polyacrylate, polyvinylidene fluoride, polyvinylidene fluoride-propylene hexafluoride copolymer, styrene-butadiene rubber, polyvinyl alcohol, polyethylene oxide, polyethylene glycol, carboxymethyl cellulose, polyacrylonitrile, polyimide, and the like. With respect to the binder, a single type thereof may be used alone or two or more types thereof may be used in combination.

Examples of the solvent in the negative electrode composition include water and organic solvents. Examples of the organic solvent include alcohols such as methanol, ethanol, 1-propanol and 2-propanol; chain or cyclic amides such as N-methylpyrrolidone and N,N-dimethylformamide; and ketones such as acetone. With respect to these solvents, a single type thereof may be used individually or two or more types thereof may be used in combination.

The sum of the amount of the negative electrode active material and the amount of the conducting agent with respect to the total mass of the negative electrode active material layer 32 is preferably 80.0 to 99.9% by mass, and more preferably 85.0 to 98.0% by mass.

### [Separator]

The separator 2 is disposed between the negative electrode 3 and the positive electrode 1 to prevent a short circuit or the like. The separator 2 may retain a non-aqueous electrolyte solution 4 described below.

The separator 2 is not particularly limited, and examples thereof include a porous polymer film, a non-woven fabric, and glass fiber.

An insulating layer may be provided on one or both surfaces of the separator 2. The insulating layer is preferably a layer having a porous structure in which insulating fine particles are bonded with a binder for an insulating layer.

The thickness of the separator 2 is, for example, 5 to 30 μm.

The separator 2 may contain at least one of plasticizers, antioxidants, and flame retardants.

Examples of the antioxidant include phenolic antioxidants such as hinderedphenolic antioxidants, monophenolic antioxidants, bisphenolic antioxidants, and polyphenolic antioxidants; hinderedamine antioxidants; phosphorus antioxidants; sulfur antioxidants; benzotriazole antioxidants; benzophenone antioxidants; triazine antioxidants; and salicylate antioxidants. Among these, phenolic antioxidants and phosphorus antioxidants are preferable.

### [Non-Aqueous Electrolyte Solution (Non-Aqueous Electrolyte)]

The non-aqueous electrolyte solution 4 fills the space between the positive electrode 1 and the negative electrode 3. For example, any of known non-aqueous electrolyte solutions used in lithium ion secondary batteries, electric double layer capacitors and the like can be used.

The non-aqueous electrolyte solution used in the manufacture of the non-aqueous electrolyte secondary battery 10 contains an organic solvent and an electrolyte. The non-aqueous electrolyte solution used in the manufacture of the non-aqueous electrolyte secondary battery 10 may further contain an additive.

The non-aqueous electrolyte secondary battery 10 after manufacture (after initial charging) contains an organic solvent and an electrolyte, and may further contain residues or traces derived from the additives.

The organic solvent is preferably one having tolerance to high voltage. Examples of the organic solvent include polar solvents such as ethylene carbonate, propylene carbonate, dimethyl carbonate, diethyl carbonate, ethyl methyl carbonate, Y-butyrolactone, sulfolane, dimethyl sulfoxide, acetonitrile, dimethylformamide, dimethylacetamide, 1,2-dimethoxyethane, 1,2-diethoxyethane, tetrahydrofuran. 2-methyltetrahydrofuran, dioxolane, and methyl acetate, as well as mixtures of two or more of these polar solvents.

The electrolyte is not particularly limited, and examples thereof include lithium-containing salts such as lithium perchlorate, lithium hexafluorophosphate, lithium tetrafluoroborate, lithium hexafluoroarsenate, lithium trifluoroacetate, lithium bis(fluorosulfonyl)imide, and lithium bis(trifluoromethanesulfonyl)imide, or mixtures of two or more of these salts.

Examples of additives includes a compound that contains one or both of a sulfur atom and a nitrogen atom. Each of the additives may be used alone, or two or more of the additives may be used in combination.

### <Method for Producing Non-Aqueous Electrolyte Secondary Battery>

Examples of the method for producing a non-aqueous electrolyte secondary battery according to the present embodiment include a method in which a positive electrode, a separator, a negative electrode, a non-aqueous electrolyte solution, an exterior body, etc. are put together by a known method to assemble a non-aqueous electrolyte secondary battery.

An example of the method for producing a non-aqueous electrolyte secondary battery according to the present embodiment is described below. For example, an electrode laminate is produced in which a positive electrode 1 and a negative electrode 3 are alternately interleaved with a separator 2 interposed therebetween. The electrode laminate is put into an exterior body 5 such as an aluminum laminate bag. Then, a non-aqueous electrolyte solution 4 is injected into the exterior body, and the exterior body 5 is sealed to produce a non-aqueous electrolyte secondary battery.

### <Porosity of Positive Electrode Active Material Layer>

In the present embodiment, the positive electrode active material layer 12 is a porous layer, and its porosity (hereinafter referred to as “porosity”. “pore ratio” or “porousness”) is 40% or less, preferably 39% or less, and more preferably 38% or less. When the porosity is not more than the upper limit value, the adhesion between the current collector coating layer and the positive electrode active material layer is excellent. For example, in the peel test described below, the adhesion can be increased so that the interface between the current collector coating layer and the positive electrode active material layer does not peel off, and cohesive failure of the positive electrode active material layer occurs. When the adhesion between the current collector coating layer and the positive electrode active material layer is increased, the resistance between the positive electrode collector and the positive electrode active material layer decreases, and the battery characteristics are improved.

The lower limit value of the porosity of the positive electrode active material layer is not particularly limited, however from the viewpoint of ion conduction, the porosity is preferably 25% or more, more preferably 30% or more, and even more preferably 35% or more.

The upper limit values and lower limit values can be arbitrarily combined.

The porosity of the positive electrode active material is preferably 25 to 40%, more preferably 30 to 29%, and even more preferably 35 to 38%. The porosity may be 30 to 39%.

Here, the porosity indicates “the percentage of the volume of voids per unit volume of the positive electrode active material layer.” The porosity in this specification is a value measured by the following measurement method.

### [Method of Measuring Porosity]

The porosity is obtained from the volume density of the electrode, the weight ratio and the true density of the electrode components.

For example, the porosity of a positive electrode active material layer consisting of a positive electrode active material, a conducting agent, and a binder can be calculated by the following formula (b1).

$$Porosity ( \% ) = ( 1 - volume density of positive electrode / true density of positive electrode active material layer ) \times 100 \qquad ( b 1 )$$

The true density of the positive electrode active material layer is calculated using the following formula (b2).

$$Density of positive electrode active material layer = 100 / ( positive electrode active material ratio / true density of active material + conducting agent ratio / true density of conducting agent + binder ratio / true density of binder ) \qquad ( b 2 )$$

When a dispersant is included, the dispersant ratio/true density of the dispersant is added to the true density of the positive electrode active material layer.

The volume density of the positive electrode is a value measured by the following measurement method.

The thickness of the positive electrode sheet and the thickness of the positive electrode current collector exposed section 13 are measured using a micrometer. Each thickness is measured at 5 arbitrarily chosen points, and an average value is calculated.

5 sheets of measurement samples are prepared by punching the positive electrode sheet into circles with a diameter of 16 mm.

Each measurement sample is weighed with a precision balance, and the mass of the positive electrode active material layer 12 in the measurement sample is calculated by subtracting the mass of the positive electrode current collector 11 measured in advance from the measurement result. The volume density of the positive electrode active material layer is calculated from the average value of measurements by the following formula (b3).

$$Volume density ( unit : g / {cm}^{3} ) = mass of positive electrode active material layer ( unit : g ) \text{} / [ ( thickness of positive electrode active material layer ( unit : cm ) ) \times area of measurement sample ( unit : {cm}^{2} ) ] \qquad ( b 3 )$$

The porosity of the positive electrode active material layer 12 can also be controlled, for example, by the pressure (press pressure) applied when pressing the laminate in which the positive electrode active material layer 12 is formed on the positive electrode current collector 11, the particle size of the positive electrode active material particles, the amount of the positive electrode active material particles, the amount of the conducting agent, and the amount of the binder in the positive electrode active material layer 12.

The porosity tends to decrease as the press pressure increases.

As an index of the adhesive strength between the current collector coating layer and the positive electrode active material layer, the peel strength (180° peel strength) of the positive electrode active material layer measured in a peel test described later can be used. The peel strength of the positive electrode active material layer is preferably 10 to 1,000 mN/cm, more preferably 20 to 500 mN/cm, and even more preferably 30 to 300 mN/cm.

The non-aqueous electrolyte secondary battery of the present embodiment can be used as a lithium ion secondary battery for various purposes such as industrial use, consumer use, automobile use, and residential use.

The application of the non-aqueous electrolyte secondary battery of the present embodiment is not particularly limited. For example, the battery can be used in a battery module configured by connecting a plurality of non-aqueous electrolyte secondary batteries in series or in parallel, a battery system including a plurality of electrically connected battery modules and a battery control system, and the like.

Examples of the battery system include battery packs, stationary storage battery systems, automobile power storage battery systems, automobile auxiliary storage battery systems, emergency power storage battery systems, and the like.

### EXAMPLES

Hereinbelow, the present invention will be described with reference to Examples which, however, should not be construed as limiting the present invention.

### <Measuring Method>

### [Method for Measuring Porosity of Positive Electrode Active Material Layer]

The porosity of the positive electrode active material layer was measured using the method described above.

### [Peel Test]

The peel strength of the positive electrode active material layer was measured by the following method.

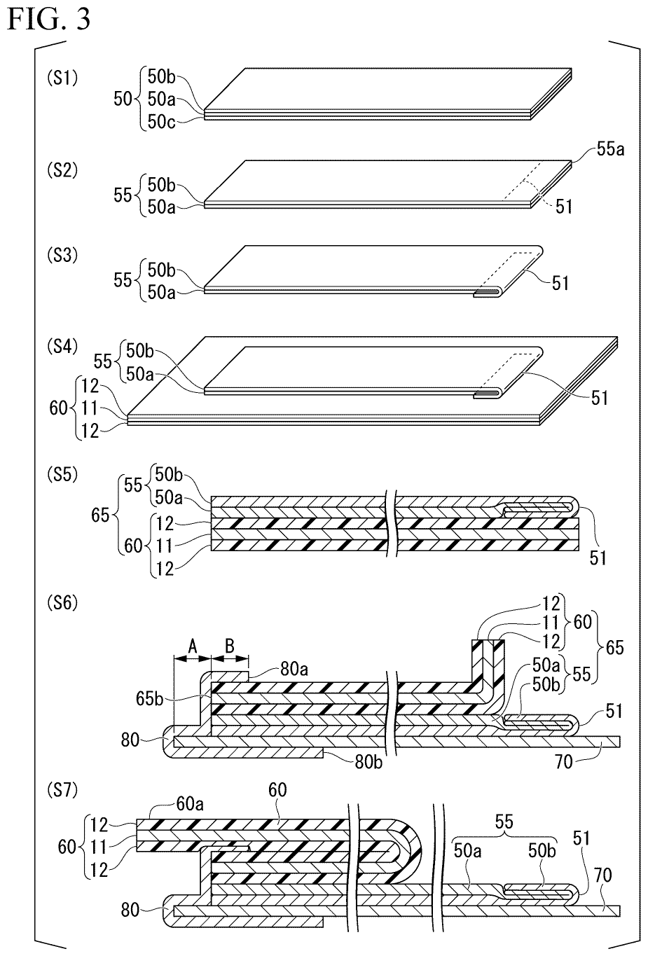

FIG. 3 is a process diagram showing a method for measuring the peel strength of the positive electrode active material layer. The steps (S1) to (S7) shown in FIG. 3 are respectively described below. FIG. 3 is a schematic diagram for facilitating the understanding of the configuration, and the dimensional ratios and the like of each component do not necessarily represent the actual ones.

(S1) First, a rectangular double-sided tape 50 having a width of 25 mm and a length of 120 mm is prepared. In the double-sided tape 50, release papers 50b and 50c are laminated on both sides of the adhesive layer 50a. As the double-sided tape 50, a product manufactured and sold by Nitto Denko Corporation with a product name “No. 5015, 25 mm width” was used.

(S2) The release paper 50c on one side of the double-sided tape 50 is peeled off to obtain an adhesive body 55 with the surface of the adhesive layer 50a (hereinafter, also referred to as “glue surface”) being exposed. In the adhesive body 55, a bending position 51 is provided at a distance of about 10 mm from one end 55a in the longitudinal direction of the adhesive body 55.

(S3) The adhesive body 55 is bent at a position on the one end 55a side as viewed from the bending position 51 such that the glue surfaces adhere to each other.

(S4) The adhesive body 55 and the positive electrode sheet 60 are bonded together such that the glue surface of the adhesive body 55 and the positive electrode active material layer 12 of the positive electrode sheet 60 are in contact with each other.

(S5) The positive electrode sheet 60 is cut out along the outer edge of the adhesive body 55, and the adhesive body 55 and the positive electrode sheet 60 are crimped to obtain a composite 65 by a method of reciprocating a crimping roller twice in the longitudinal direction.

(S6) The outer surface of the composite 65 on the adhesive body 55 side is brought into contact with one surface of a stainless plate 70, and the other end 65b on the side opposite to the bending position 51 is fixed to the stainless plate 70 with a mending tape 80. As the mending tape 80, a product manufactured and sold by 3M Company with a product name “Scotch Tape Mending Tape 18 mm×30 Small Rolls 810-1-18D” is used. The length of the mending tape 80 is about 30 mm, the distance A from an end of the stainless plate 70 to the other end 65b of the composite 65 is about 5 mm, and the distance B from one end 80a of the mending tape 80 to the other end 65b of the composite 65 is 5 mm. The other end 80b of the mending tape 80 is attached to the other surface of the stainless plate 70.

(S7) At the end of the composite 65 on the bending position 51 side, the positive electrode sheet 60 is slowly peeled off from the adhesive 55 in parallel with the longitudinal direction. The end (hereinafter, referred to as “peeling end”) 60a of the positive electrode sheet 60 that is not fixed by the mending tape 80 is slowly peeled off until it protrudes from the stainless steel plate 70.

Next, the stainless plate 70 to which the composite 65 is fixed is installed on a tensile tester (product name “EZ-LX”, manufactured by Shimadzu Corporation) (not shown), the end of the adhesive 55 on the bending position 51 side is fixed, and the peeling end 60a of the positive electrode sheet 60 is pulled in the direction opposite to the bending position 51 (180° direction with respect to the bending position 51) at a test speed of 60 mm/min, a test force of 50,000 mN, and a stroke of 70 mm to measure the peel strength. The average value of the peel strength at a stroke of 20 to 50 mm is taken as the peel strength of the positive electrode active material layer 12.

(S8) The peeling state was observed after the peeling test. When the interface between the positive electrode active material layer 12 in close contact with the adhesive layer 50a and the positive electrode current collector 11 in the positive electrode sheet 60, i.e., the interface between the positive electrode active material layer 12 and the current collector coating layer, peeled off, it was judged as “interface peeling”. When the positive electrode active material layer 12 in close contact with the adhesive layer 50a was broken, it was judged as “cohesive failure”.

### <Evaluation Method>

### [High Temperature Deterioration Resistance]

Using a cell fabricated so as to have a rated capacity of 1 Ah, the resistance to high temperature degradation was evaluated according to the following procedures (1) to (6).

(1) In an environment of 25° C., the obtained cell was charged at a constant current rate of 0.2 C rate (that is, 200 mA) and with a cut-off voltage of 3.6 V, and then charged at a constant voltage with a cut-off current set at ¼ of the above-mentioned charge current (that is, 50 mA).

(2) The cell was discharged for capacity confirmation in an environment of 25° C., at a constant current rate of 0.2 C and with a cut-off voltage of 2.5 V. The discharge capacity at this time was set as the reference capacity, and the reference capacity was set as the current value at 1 C rate (that is, 1,000 mA).

(3) In an environment of 25° C., the cell was charged at a constant current rate of 0.2 C rate (that is, 200 mA) and with a cut-off voltage of 3.6 V, and then charged at a constant voltage with a cut-off current set at ¼ of the above-mentioned charge current (that is, 50 mA). The cell was then stored at 75° C.

(4) After storing for 24 hours, the cell was left to stand in an environment of 25° C., for 2 hours, and then discharged at a constant current of 0.2 C rate to a cut-off voltage of 2.5 V.

(5) The discharge capacity after storage at 75° C., measured in (4) above was divided by the discharge capacity measured in (3) above to obtain a percentage, thereby calculating the capacity retention rate (unit: %).

(6) The steps (3) to (5) were repeated until the capacity retention rate became less than 80%, and the capacity retention rate versus the number of days was plotted to determine the number of days until the capacity retention rate became less than 80%. The longer this number, the better the resistance of the cell to high-temperature deterioration.

### <Materials Used>

### [Negative Electrode]

The negative electrode produced in Negative Electrode Production Example 1 below.

### [Current Corrector]

The current collector having a current collector coating layer, produced in the following Current Collector Production Example 1.

### [Positive Electrode Active Material Particles]

As the positive electrode active material particles, coated particles having a core section formed of lithium iron phosphate and an coating section formed of a low crystalline carbon (hereinafter referred to as “LFP coated particles”) were used.
LFP (1): LFP coated particles with an average particle size of 1.2 μm, carbon content of 1.1% by mass, and coating type of low-crystalline carbon.
LFP (2): LFP coated particles with an average particle size of 1.1 μm, carbon content of 1.1% by mass, and coating type of low-crystalline carbon.
LFP (3): LFP coated particles with an average particle size of 10.0 μm, carbon content of 1.5% by mass, and coating type of low-crystalline carbon.
LFP (4): LFP coated particles with an average particle size of 11.0 μm, carbon content of 2.0% by mass, and coating type of low-crystalline carbon.
LFP (5): LFP coated particles with an average particle size of 15.0 μm, carbon content of 2.5% by mass, and coating type of low-crystalline carbon.

The true density of lithium iron phosphate is 3.55 g/cm³. The true density of the coating section is 1.7 g/cm³.

### <Others>

Carbon black (CB) was used as the conducting agent. Impurities in the CB were below the quantification limit, and the carbon amount can be considered to be 100% by mass. The true density of CB is 2.3 g/cm³.

Polyvinylidene fluoride (PVDF) was used as binder. The true density of PVDF is 1.78 g/cm³.

N-methylpyrrolidone (NMP) was used as a solvent.

### <Negative Electrode Production Example 1: Production of Negative Electrode>

100 parts by mass of artificial graphite as a negative electrode active material, 1.5 parts by mass of styrene-butadiene rubber as a binder, 1.5 parts by mass of carboxymethyl cellulose Na as a thickener, and water as a solvent were mixed, to thereby obtain a negative electrode composition having a solid content of 50% by mass.

The obtained negative electrode composition was applied onto both sides of an 8 μm-thick copper foil and vacuum dried at 100° C., to obtain a negative electrode active material layer. The coating amount of the negative electrode composition was 20 mg/cm² (total amount for both sides). The negative electrode active material layers on both surfaces of the negative electrode current collector were formed so as to have the same coating amount and the same thickness. After coating, the coating was pressure-pressed at a line pressure of 2 kN to obtain a negative electrode sheet. The obtained negative electrode sheet was punched to obtain a negative electrode.

<Current Collector Production Example 1: Production of Current Collector (with Current Collector Coating Layer)>

A positive electrode current collector was prepared by coating both the front and back surfaces of a positive electrode current collector main body with current collector coating layers by the following method. A 15 μm-thick aluminum foil was used as the positive electrode current collector main body.

Carbon black, a binder, conductive carbon, and pure water as a solvent were mixed together to obtain a slurry. The amount of pure water used was the amount required for applying the slurry.

The obtained slurry was applied to both surfaces of the positive electrode current collector main body by a gravure method and dried to remove the solvent to form current collector coating layers, thereby obtaining a positive electrode current collector.

### Examples 1 to 15

Examples 1 to 7, and 13 are implementation of the present invention, while Examples 8 to 12, 14, and 15 8 are comparative examples.

A positive electrode active material layer was formed by the following method.

With the blending ratio shown in Table 1, the positive electrode active material particles, the conducting agent, the binder, and the solvent were mixed with a mixer to obtain a positive electrode composition. The amount of the solvent used was the amount required for applying the positive electrode composition.

The obtained positive electrode composition was applied onto both sides of the positive electrode current collector, and after pre-drying, the applied composition was vacuum-dried at 120° C., to form positive electrode active material layers. Then, the resulting was pressure-pressed at the pressure (linear pressure) shown in Table 1 to obtain a positive electrode sheet. The coating volume of the positive electrode composition was 20.0 mg/cm² (total volume for both sides). The positive electrode active material layers on both surfaces of the positive electrode current collector were formed so as to have the same coating amount and the same thickness.

With respect to the obtained positive electrode sheet, the mount of conductive carbon with respect to the total mass of the positive electrode active material layer was determined. The results are shown in Table 1.

The amount of conductive carbon with respect to the total mass of the positive electrode active material layer was calculated based on the carbon content and blending amount of the positive electrode active material particles as well as the carbon content and blending amount of the conducting agent. The amount of conductive carbon can also be confirmed by the <<Method for measuring amount of conductive carbon>>described above.

Using the obtained positive electrode sheet as a sample, the porosity was measured and a peel test was performed using the method described above. The results are shown in Table 1.

The obtained positive electrode sheet was punched to obtain a positive electrode.

### <Production of Non-Aqueous Electrolyte Secondary Battery>

A non-aqueous electrolyte secondary battery having a configuration shown in FIG. 2 was manufactured by the following method.

Lithium hexafluorophosphate as an electrolyte was dissolved at 1 mol/L in a solvent in which ethylene carbonate (EC) and diethyl carbonate (DEC) were mixed at a volume ratio, EC: DEC, of 3:7, to thereby prepare a non-aqueous electrolytic solution.

The positive electrode obtained in each of the Examples and the negative electrode were alternately interleaved through a separator to prepare an electrode laminate with its outermost layer being the negative electrode. As a separator, a polyolefin film having a thickness of 15 μm was used.

In the step of producing the electrode laminate, the separator 2 and the positive electrode 1 were first stacked, and then the negative electrode 3 was stacked on the separator 2.

Terminal tabs were electrically connected to the positive electrode current collector exposed section 13 and the negative electrode current collector exposed section 33 in the electrode laminate, and the electrode laminate was put between aluminum laminate films while allowing the terminal tabs to protrude to the outside. Then, the resulting was laminate-processed and sealed at three sides.

To the resulting structure, a non-aqueous electrolytic solution was injected from one side left unsealed, and this one side was vacuum-sealed to manufacture a non-aqueous electrolyte secondary battery (laminate cell).

The resulting laminate cell was evaluated for high temperature deterioration resistance by the above-mentioned method. The results are shown in Table 1.

TABLE 1

| | Positive electrode active material layer | | | | | |
|---|---|---|---|---|---|---|
| | Positive electrode active | | | | | |
| | material particles | | | | | |
| | (coated particles) | | Conducting agent | | Binder | |
| | | Blend amount | | Blend amount | | Blend amount |
| | Type | [parts by mass] | Type | [parts by mass] | Type | [parts by mass] |
| Ex. 1 | LFP(1) | 100 | — | 0 | PVDF | 1 |
| Ex. 2 | LFP(2) | 100 | — | 0 | PVDF | 1 |
| Ex. 3 | LFP(3) | 100 | — | 0 | PVDF | 1 |
| Ex. 4 | LFP(1) | 100 | CB | 1 | PVDF | 1 |
| Ex. 5 | LFP(3) | 100 | CB | 2 | PVDF | 1 |
| Ex. 6 | LFP(1) | 100 | CB | 2.5 | PVDF | 1 |
| Ex. 7 | LFP(4) | 100 | — | 0 | PVDF | 1 |
| Ex. 8 | LFP(1) | 100 | — | 0 | PVDF | 1 |
| Ex. 9 | LFP(1) | 100 | — | 0 | PVDF | 1 |
| Ex. 10 | LFP(3) | 100 | — | 0 | PVDF | 1 |
| Ex. 11 | LFP(3) | 100 | — | 0 | PVDF | 1 |
| Ex. 12 | LFP(3) | 100 | CB | 3 | PVDF | 1 |
| Ex. 13 | LFP(5) | 100 | CB | 1 | PVDF | 1 |
| Ex. 14 | LFP(5) | 100 | CB | 1.6 | PVDF | 1 |
| Ex. 15 | LFP(1) | 100 | CB | 3.1 | PVDF | 1 |

High
temperature

deterioration
resistance
Number of
days with

| | | |
|---|---|---|
| Conductive | Peeling test | battery |

| | carbon | Line | | Peel | | capacity |
|---|---|---|---|---|---|---|
| | content | pressure | Porosity | strength | Peeling state | below 80% |
| | % by mass | kN/m | % | mN/cm | — | days |
| Ex. 1 | 1.1 | 1.8 | 35 | 47.1 | Cohesive failure | 10 |
| Ex. 2 | 1.1 | 1.8 | 37 | 64.2 | Cohesive failure | 10 |
| Ex. 3 | 1.5 | 1.8 | 38 | 40.2 | Cohesive failure | 10 |
| Ex. 4 | 2.1 | 1.8 | 36 | 48.3 | Cohesive failure | 9.5 |
| Ex. 5 | 3.4 | 1.8 | 39 | 39.2 | Cohesive failure | 9 |
| Ex. 6 | 3.5 | 2.4 | 28 | 66.8 | Cohesive failure | 9 |
| Ex. 7 | 2 | 1.8 | 39 | 39.5 | Cohesive failure | 10 |
| Ex. 8 | 1.1 | 0 | 50 | 0.4 | Interface peeling | 7.5 |
| Ex. 9 | 1.1 | 0.6 | 45 | 25.0 | Interface peeling | 8.5 |
| Ex. 10 | 1.5 | 0 | 54 | 0.2 | Interface peeling | 7.5 |
| Ex. 11 | 1.5 | 1.3 | 48 | 18.8 | Interface peeling | 8.5 |
| Ex. 12 | 4.5 | 1.8 | 40 | 38.5 | Cohesive failure | 6 |
| Ex. 13 | 3.4 | 1.8 | 38 | 40.2 | Cohesive failure | 9 |
| Ex. 14 | 4.0 | 1.8 | 39 | 42.3 | Cohesive failure | 8 |
| Ex. 15 | 4.0 | 1.8 | 37 | 45.2 | Cohesive failure | 7.5 |

As shown in Table 1, the positive electrodes for non-aqueous electrolyte secondary batteries of Examples 1 to 7 and 13, in which the porosity of the positive electrode active material layer was 40% or less and the amount of conductive carbon was 0.5 to 3.5% by mass, had high peel strength, underwent cohesive failure of the positive electrode active material layer in the peel test, and were also excellent in resistance to high temperature deterioration. Cohesive failure of the positive electrode active material layer indicates that the adhesive strength at the interface between the current collector coating layer and the positive electrode active material layer is high.

On the other hand, the positive electrodes for non-aqueous electrolyte secondary batteries in Examples 8 to 11, in which the porosity of the positive electrode active material layer exceeded 40%, had low peel strength, and peeling occurred at the interface between the current collector coating layer and the positive electrode active material layer in the peel test. Furthermore, when the porosity exceeded 40%, the number of reaction sites increased even with the same amount of conductive carbon, making high temperature deterioration more likely to progress.

In Examples 12, 14, and 15, even when the porosity was 40% or less, when the amount of conductive carbon exceeded 3.5%, the high temperature deterioration resistance in the secondary battery was poor. This indicates that the conducting agent increased the number of reaction sites.

### REFERENCE SIGNS LIST

1 Positive electrode
2 Separator
3 Negative electrode
4 Non-aqueous electrolyte solution
5 Outer casing
10 Non-aqueous electrolyte secondary battery
11 Positive electrode current collector
12 Positive electrode active material layer
13 Positive electrode current collector exposed section
14 Positive electrode current collector main body
15 Current collector coating layer
31 Negative electrode current collector
32 Negative electrode active material layer
33 Negative electrode current collector exposed section
50 Double-sided tape
50a Adhesive layer
50b Release paper
50c Release paper
51 Bending position
55 Adhesive body
55a One end of adhesive body
60 Positive electrode sheet
60a Edge of positive electrode sheet (peeling end)
65 Composite of adhesive body and positive electrode sheet
65b Other end of composite
70 Stainless steel plate
80 Mending tape
80a One end of mending tape
80b Other end of mending tape

1. A positive electrode for a non-aqueous electrolyte secondary battery, comprising a positive electrode current collector and a positive electrode active material layer present on the positive electrode current collector, wherein:
the positive electrode current collector has, on at least a part of its surface on a side of the positive electrode active material layer, a current collector coating layer comprising a conductive material,
the positive electrode active material layer comprises a positive electrode active material and a conductive carbon,
the positive electrode active material layer comprises positive electrode active material particles,
the positive electrode active material particles comprise coated particles having a core section which is the positive electrode active material and an active material coating section comprising the conductive carbon,
the positive electrode active material comprises a compound represented by a formula LiFeₓM₍₁₋ₓ₎PO₄, wherein 0≤x≤1, Mis Co, Ni, Mn, Al, Ti or Zr,
the positive electrode active material layer has a porosity of 40% or less, and
an amount of the conductive carbon is 0.5 to 3.5% by mass with respect to a total mass of the positive electrode active material layer.

2. The positive electrode according to claim 1, wherein the positive electrode active material layer comprises a binder, and
wherein the binder comprises polyvinylidene fluoride.

3. A non-aqueous electrolyte secondary battery, comprising the positive electrode of claim 1, a negative electrode, and a non-aqueous electrolyte disposed between the positive electrode and the negative electrode.

4. A battery module or battery system comprising a plurality of the non-aqueous electrolyte secondary batteries of claim 3.

5. A non-aqueous electrolyte secondary battery, comprising the positive electrode of claim 2, a negative electrode, and a non-aqueous electrolyte disposed between the positive electrode and the negative electrode.

6. A battery module or battery system comprising a plurality of the non-aqueous electrolyte secondary batteries of claim 5.
